(19) United States
(12) Patent Application Publication
(10) Pub. No.: US 2018/0207996 A1
(43) Pub. Date: Jul. 26, 2018

(54) TREAD WEAR INDICATOR

(71) Applicant: The Goodyear Tire & Rubber Company, Akron, OH (US)

(72) Inventors: Jesse Brian Serva, Akron, OH (US); Thomas Andrew Laurich, Fairlawn, OH (US); Denise Monk Munday, Statesville, NC (US); Marc Christopher Nowacki, Uniontown, OH (US); Jason David Rismiller, Medina, OH (US); Warren Lee Croyle, Wadsworth, OH (US)

(21) Appl. No.: 15/413,512

(22) Filed: Jan. 24, 2017

(51) Int. Cl. B60C 11/24

(52) U.S. Cl. CPC B60C 11/24

(57) ABSTRACT

A tread wear indicator for a tire is provided. The tire includes a pair of sidewalls and a tread and the tread includes a plurality of tread elements defined by circumferential grooves and lateral grooves. The tread wear indicator is formed in a selected one of the tread elements adjacent a selected one of the circumferential grooves. The indicator includes a plurality of step elements descending from a radially outward surface of the selected one of the tread elements toward the base of the selected one of the circumferential grooves. Each step element includes an axially-extending surface that is approximately parallel to and is radially inward of the radially outward surface of the selected one of the tread elements, and a radially-extending surface that extends approximately perpendicular to the axially-extending surface. The axially-extending surface of each step element is formed with indicia visible to a user of the tire.

### FIELD OF THE INVENTION

The invention relates to pneumatic tires and to tread wear indicators for such tires. More particularly, the invention is directed to a visual tread wear indicator that is economical to form and is easy for a user to read.

### BACKGROUND OF THE INVENTION

In the pneumatic tire art, it is known that, as the tread of the tire wears away, the ability to maintain traction may diminish on wet or snow-covered roads. Accordingly, once the tread is worn beyond a certain tread depth, the tire should be replaced to maintain adequate traction.

In order to inform a vehicle user when a tire may need to be replaced due to tread wear, prior art tread wear indicators were developed. For example, some tread wear indicators involved providing features molded in the base of the circumferential grooves of the tire tread. However, such tread wear indicators may undesirably interfere with the flow of water and materials through the groove. In addition, due to their placement in a groove, they may be difficult for a user to see.

Other indicators were developed, which we located in the tread elements of the tires. However, many such prior art indicators have undesirably interfered with tread performance and/or were difficult for a user to see. An additional disadvantage of prior art indicators that were disposed in the tread is that the indicators were of a simple configuration which wore away before the user saw or understood the wear indication.

Still other indicators were developed that involve sensors which measure tire wear and provide an alert or signal to the user as to the wear state of the tire. While such sensors are suitable for their intended purpose, they add to the cost of the tire.

As a result, there is a need in the art for a tread wear indicator for a pneumatic tire that is easy for a user to see, does not interfere with groove or tread element performance, and is economical to form.

### SUMMARY OF THE INVENTION

According to an aspect of an exemplary embodiment of the invention, a tire includes a pair of sidewalls and a tread, and the tread includes a plurality of tread elements defined by circumferential grooves and lateral grooves. The tread wear indicator is formed in a selected one of the tread elements adjacent a selected one of the circumferential grooves. The indicator includes a plurality of step elements descending from a radially outward surface of the selected one of the tread elements toward the base of the selected one of the circumferential grooves. Each step element includes an axially-extending surface that is approximately parallel to and is radially inward of the radially outward surface of the selected one of the tread elements, and a radially-extending surface that extends approximately perpendicular to the axially-extending surface. The axially-extending surface of each step element is formed with indicia visible to a user of the tire.

### DEFINITIONS

The following definitions are applicable to the present invention.

“Axial” and “axially” mean lines or directions that are parallel to the axis of rotation of the tire.

“Equatorial plane” means the plane perpendicular to the axis of rotation of the tire and passing through the center of the tire tread.

“Groove” means an elongated void area in a tread that may extend circumferentially or laterally about the tread in a straight curved, or zigzag manner.

“Inner” means toward the inside of the tire.

“Lateral” and “laterally” are used to indicate axial directions across the tread of the tire.

“Outer” means toward the outside of the tire.

“Radial” and “radially” are used to mean directions radially toward or away from the axis of rotation of the tire.

“Sipe” means a small elongated opening in the tread that improves traction characteristics.

“Tread” means a molded rubber component which includes that portion of the tire that comes into contact with the road when the tire is normally inflated and under normal load. The tread has a depth conventionally measured from the tread outer surface to the bottom of the deepest groove of the tire.

### BRIEF DESCRIPTION OF THE DRAWINGS

The invention will be described by way of example and with reference to the accompanying drawings, in which:

FIG. 1 is a fragmentary perspective view of a tire including a first exemplary embodiment of the tread wear indicator of the present invention;

FIG. 2 is an enlarged fragmentary perspective view of the tire and tread wear indicator from the circled area shown in FIG. 1;

FIG. 3 is a fragmentary plan view of the tire and tread wear indicator shown in FIG. 1;

FIG. 4 is a cross-sectional view of the tire and tread wear indicator taken along line 4-4 in FIG. 3;

FIG. 5 is a perspective view of a mold insert used to form the tread wear indicator shown in FIG. 1;

FIG. 6 is a fragmentary perspective view of a tire including a second exemplary embodiment of the tread wear indicator of the present invention;

FIG. 7 is an enlarged fragmentary perspective view of the tire and tread wear indicator from the circled area shown in FIG. 6;

FIG. 8 is a fragmentary plan view of the tire and tread wear indicator shown in FIG. 6;

FIG. 9 is a cross-sectional view of the tire and tread wear indicator taken along line 9-9 in FIG. 8; and

FIG. 10 is a perspective view of a mold insert used to form the tread wear indicator shown in FIG. 6.

Similar numerals refer to similar parts throughout the drawings.

### DETAILED DESCRIPTION OF THE INVENTION

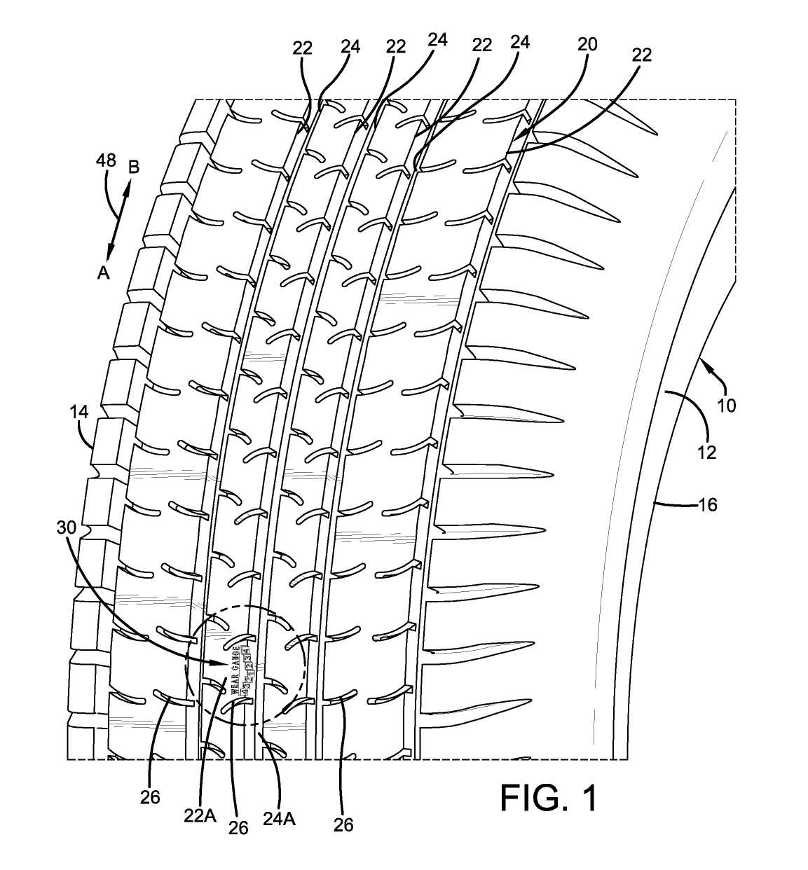

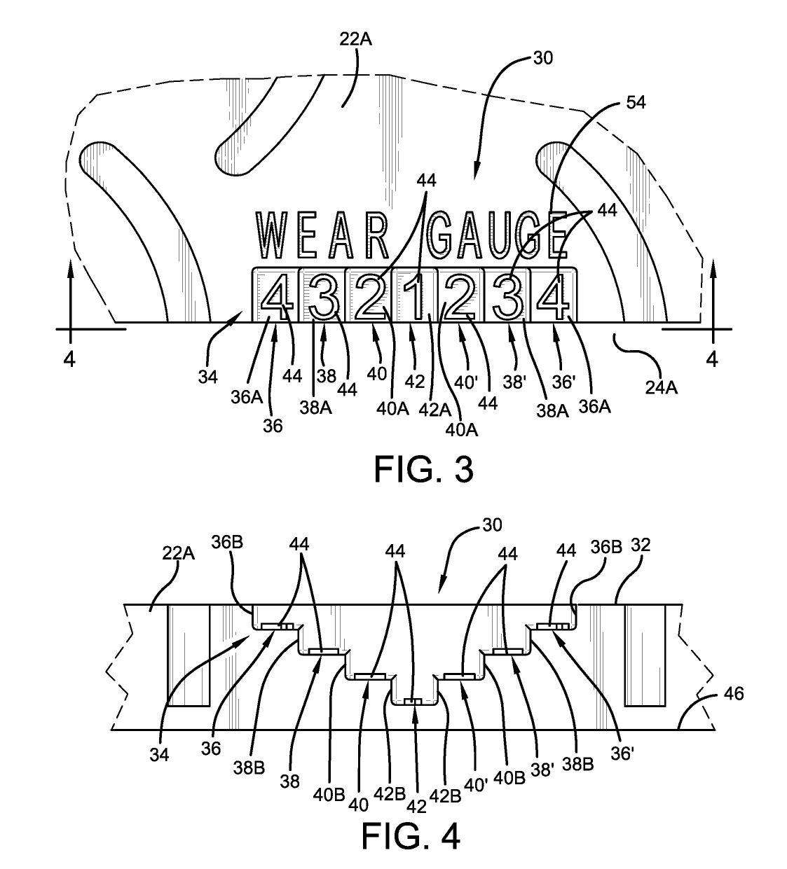

Turning first to FIGS. 1 through 4, an exemplary tire is indicated at 10 and includes a pair of sidewalls 12 and 14 extending from respective bead areas 16 (only one shown) to a tread 20. The tread 20 includes a plurality of tread elements 22 that are defined by circumferential grooves 24 and lateral grooves 26. It is to be understood that any tread configuration may be employed with the present invention. Formed in a selected one of the tread elements 22A is a first exemplary embodiment of the tread wear indicator of the present invention, indicated generally at 30. It is to be further understood that the tread wear indicator 30 may be formed in any one of the tread elements 22, and that the tire 10 may include more than one tread wear indicator.

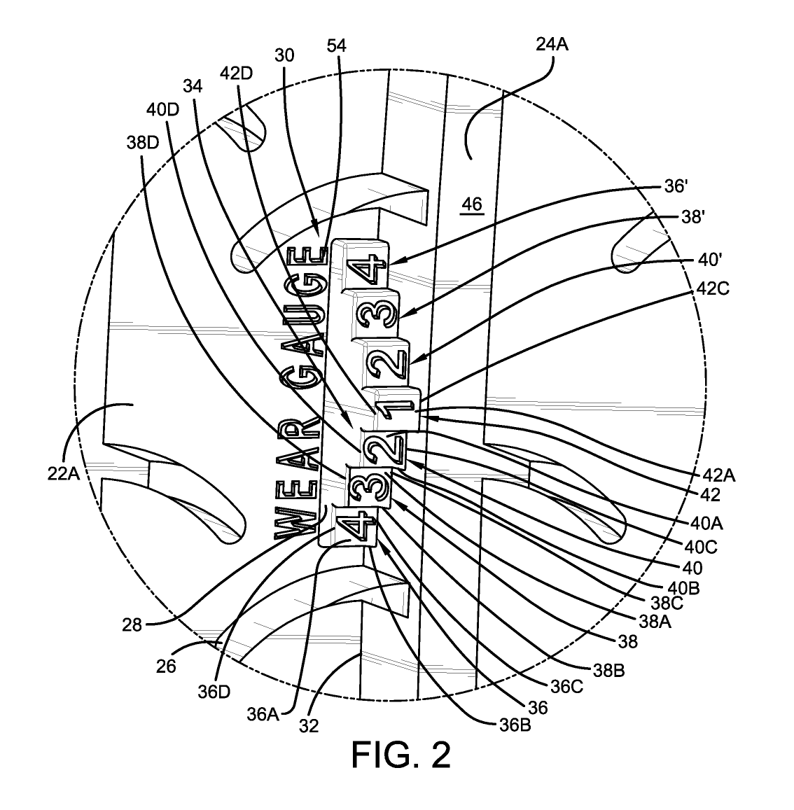

Referring now to FIGS. 2 through 4, the tread wear indicator 30 is formed at the edge of the selected tread element 22A adjacent a selected one of the circumferential grooves 24A. The first embodiment tread wear indicator 30 is formed with a double staircase configuration. More particularly, a plurality of step elements 34 descends from the radially outward tread surface 32 toward the bottom or base surface 46 of the selected circumferential groove 24A. The tread wear indicator includes at least two elements 34, and preferably four or more elements. As will be described below, each element 34 is similar to the other elements in shape and configuration.

For example, a first step 36 includes an axially-extending surface 36A that is approximately parallel to and radially inward of the outward tread surface 32. Preferably, the axially-extending surface 36A is formed with a square or rectangular shape. A radially-extending surface 36B extends from the radially outward tread surface 32 to the axially-extending surface 36A in an approximately perpendicular manner. A first side edge 36C of the axially-extending surface 36A is disposed adjacent the selected groove 24A, and a second side edge 36D of the axially-extending surface is disposed against a wall area 28 formed in the selected tread element 22A.

A second step 38 includes an axially-extending surface 38A that is parallel to and radially inward of the axially-extending surface 36A of the first step 36. Preferably, the axially-extending surface 38A is formed with a square or rectangular shape. A radially-extending surface 38B extends from the axially-extending surface 36A of the first step 36 to the second step axially-extending surface 38A in an approximately perpendicular manner. A first side edge 38C of the axially-extending surface 38A is disposed adjacent the selected groove 24A, and a second side edge 38D of the axially-extending surface is disposed against the wall area 28 formed in the selected tread element 22A.

A third step 40 includes an axially-extending surface 40A that is parallel to and radially inward of the axially-extending surface 38A of the second step 38. Preferably, the axially-extending surface 40A is formed with a square or rectangular shape. A radially-extending surface 40B extends from the axially-extending surface 38A of the second step 38 to the second step axially-extending surface 40A in an approximately perpendicular manner. A first side edge 40C of the axially-extending surface 40A is disposed adjacent the selected groove 24A, and a second side edge 40D of the axially-extending surface is disposed against the wall area 28 formed in the selected tread element 22A.

A fourth or bottom step 42 includes an axially-extending surface 42A that is parallel to and radially inward of the axially-extending surface 40A of the third step 40. Preferably, the axially-extending surface 42A is formed with a square or rectangular shape. A radially-extending surface 42B extends from the axially-extending surface 40A of the third step 40 to the second step axially-extending surface 42A in an approximately perpendicular manner. A first side edge 42C of the axially-extending surface 42A is disposed adjacent the selected groove 24A, and a second side edge 42D of the axially-extending surface is disposed against the wall area 28 formed in the selected tread element 22A.

As mentioned above, the first embodiment of the tread wear indicator 30 is formed with a double staircase configuration. The first set of step elements 36, 38, and 40 descends from the radially outward tread surface 32 to the bottom step 42 as described above. In the double staircase configuration, a second set of step elements includes a first opposing step 36′ that is similar in configuration to the first step 36 and is disposed on the opposite side of the bottom step 42 from the first step. A second opposing step 38′ is similar in configuration to the second step 38 and is disposed on the opposite side of the bottom step 42 from the second step. A third opposing step 40′ is similar in configuration to the third step 40 and is disposed on the opposite side of the bottom step 42 from the third step. In this manner, the first embodiment of the tread wear indicator 30 includes opposing steps 36 and 36′, 38 and 38′, 40 and 40′, which descend from the radially outward tread surface 32 to the single bottom step 42.

The height of each one of the step elements 34 is based upon the number of steps and the minimum desired indicator height employed for a particular configuration of the tread wear indicator 30. For example, the axially-extending surface 42A of the bottom step 42, which is at the minimum desired indicator height, may be disposed about 1.9 millimeters above the base 46 of the selected circumferential groove 24A. This is a recommended minimum tread depth, and is based upon particular design considerations for the tire 10. As a result, the specific height of the axially-extending surface 42A of the bottom step 42 above the bottom of the groove 24A may vary for different types of tires 10.

The axially-extending surface 42A of the bottom step 42 is thus considered to be zero percent of the recommended tread height, while the new, unworn surface 32 of the tread element 22A is considered to be 100 percent of the recommended tread height. Each step 36, 36′, 38, 38′, 40, 40′, 42 is at a set height which corresponds to a specific percentage of the recommended tread height. For example, the axially-extending surface 36A of the first step 36 and the axially-extending surface of its opposing step 36′ are each at a height that corresponds to 75 percent of the difference between the height of the axially-extending surface 42A of the bottom step 42 and the unworn tread element surface 32. The axially-extending surface 36A of the first step 36 and its opposing step 36′ thus indicate a level or height at which 75 percent of the recommended tread height remains.

The axially-extending surface 38A of the second step 38 and the axially-extending surface of its opposing step 38′ are each at a height that corresponds to 50 percent of the difference between the height of the axially-extending surface 42A of the bottom step 42 and the unworn tread element surface 32. The axially-extending surface 38A of the second step 38 and its opposing step 38′ thus indicate a level or height at which 50 percent of the recommended tread height remains. The axially-extending surface 40A of the third step 40 and the axially-extending surface of its opposing step 40′ each are at a height that corresponds to 25 percent of the difference between the height of the axially-extending surface 42A of the bottom step 42 and the unworn tread element surface 32. The axially-extending surface 40A of the third step 40 and its opposing step 40′ thus indicate a level or height at which 25 percent of the recommended tread height remains. As described above, the axially-extending surface 42A of the last step 42 indicates a height at which 0 percent of the recommended tread height remains and tire replacement should occur.

Each step preferably is formed with indicia 44 for easy identification by a user. For example, the axially-extending surface 36A of the first or highest step 36 and its opposing step 36′ each are formed with the number “4”, which is easily seen by a user. The axially-extending surface 38A of the second step 38 and its opposing step 38′ each are formed with the number “3”, and the axially-extending surface 40A of the third step 40 and its opposing step 40′ each are formed with the number “2”. The axially-extending surface 42A of the fourth or bottom step 42 is formed with the number “1”.

Preferably, the indicia 44 correspond to a predetermined percentage of the recommended tread height. As described above, the bottom step 42 is at zero percent of the recommended tread height and bears the number “1”, which as the lowest positive integer, indicates to a user a need for replacement. The third step 40 and its opposing step 40′ are at a level or height at which 25 percent of the recommended tread height remains and each bears the number “2”. The second step 38 and its opposing step 38′ are at a level or height at which 50 percent of the recommended tread height remains and each bears the number “3”. The first step 36 and its opposing step 36′ are at a level or height at which 75 percent of the recommended tread height remains and each bears the number “4”. The number “4” is the highest integer for the indicia 44 by way of example for the first embodiment of the tread wear indicator 30, and indicates to a user that a considerable amount of tread remains.

The indicia 44 are preferably oriented toward an outboard surface of the tire 10, thereby enabling the user to easily read them. The use of such clear number-based indicia 44 as described above allows a “countdown” of the remaining tread life of the tire 10, which provides an indicator that is easy for a user to see and understand.

The double staircase configuration of the first embodiment of the tread wear indicator 30 enables the tread wear in a forward direction of tire rotation to be compared to a reverse direction, as indicated as “A” and “B” along arrow 48 (FIG. 1). Wear in the forward and reverse rotational directions is referred to as “heel-toe tread wear”, and may be beneficial to a user in indicating to the user whether the tire 10 is wearing uniformly.

By being located in the selected tread element 22A adjacent the selected groove 24A, the tread wear indicator 30 is easy for a user to see, does not interfere with the performance of the grooves 24 and 26 or the tread 20, and is economical to form.

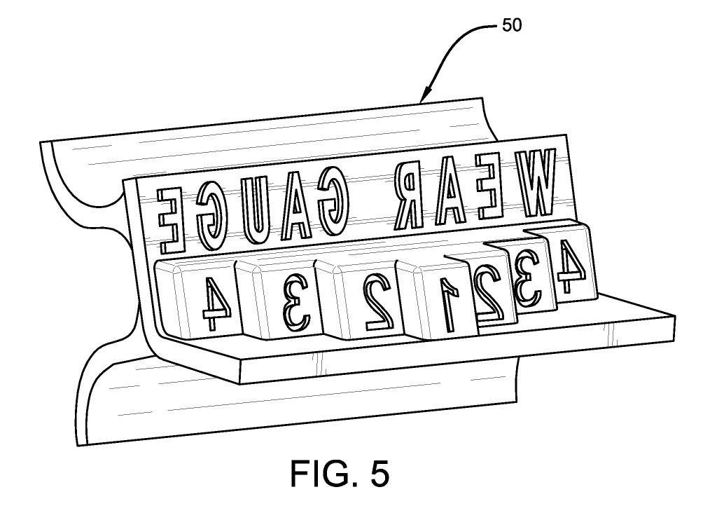

Turning to FIG. 5, the tread wear indicator 30 preferably is formed in the tire 10 when the tire is cured. As is known in the art, the tire 10 is cured in a mold (not shown). During curing, the tread 20 is formed. To form the tread wear indicator 30, a die insert 50 is formed with the above-described features of the tread wear indicator. The die insert 50 is disposed in a corresponding opening formed in the tire curing mold, and when the tread 20 is formed on the tire 10 during curing, the tread wear indicator 30 is also formed. The die insert 50 may be 3D printed, cast or fabricated, and may be formed of any suitable mold material, including steel, aluminum and alloys thereof.

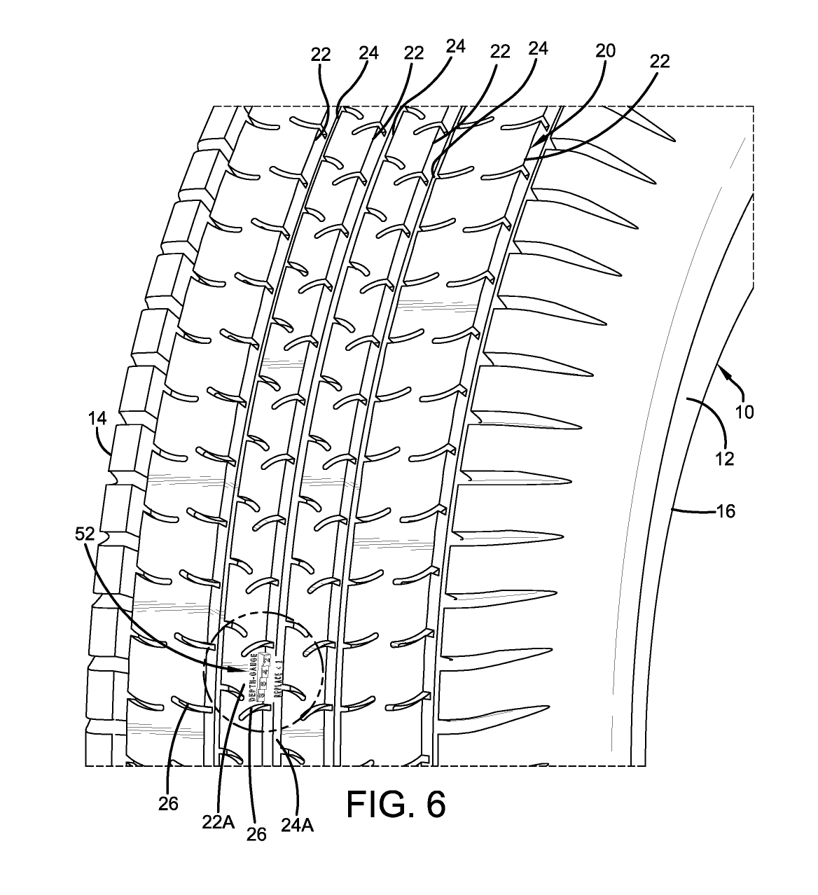

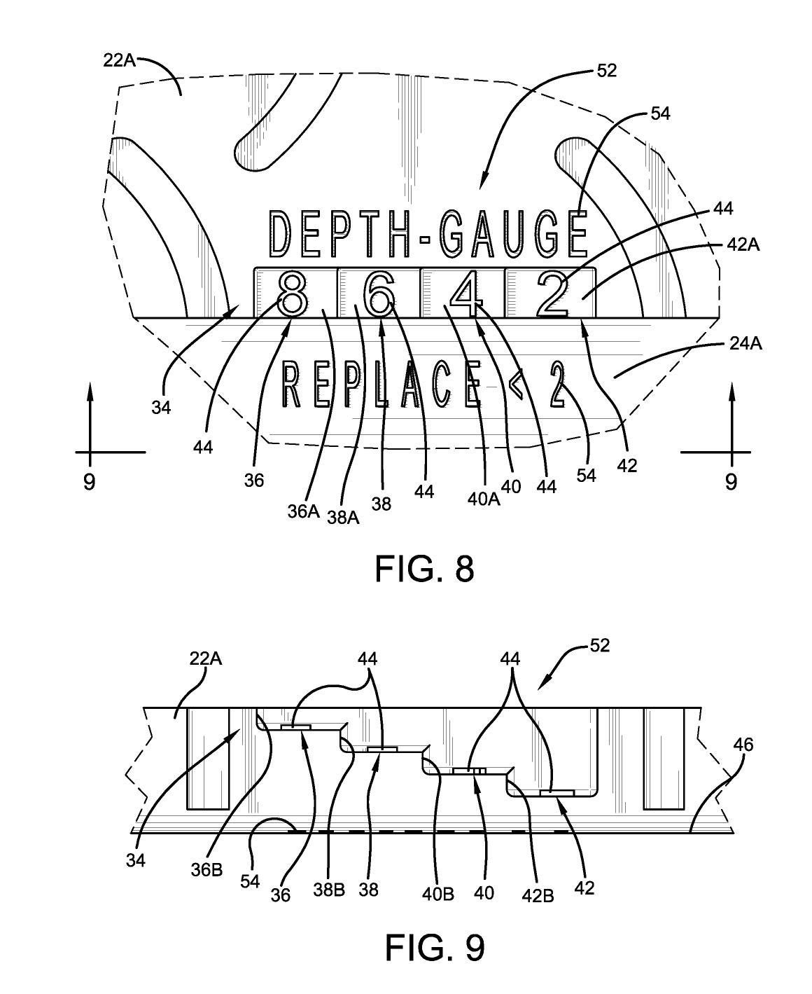

Referring now to FIGS. 6 through 9, a second exemplary embodiment of a tread wear indicator of the present invention is indicated at 52. The second embodiment of the tread wear indicator 52 is similar in location, construction and operation to the first embodiment of the tread wear indicator 30, except that the second embodiment is formed with a single staircase configuration, rather than a double staircase configuration. As a result, the description above for the first embodiment of the tread wear indicator 30 applies to the second embodiment of the tread wear indicator 52, with the exception that the opposing first step 36′, the opposing second step 38′ and the opposing third step 40′ are not employed in the second embodiment of the indicator.

In addition, the indicia 44 of the second embodiment of the tread wear indicator 52 include numbers that are different from those of the first embodiment of the tread wear indicator 30. For example, the first or highest step 36 is formed with the number “8” on the axially-extending surface 36A, the second step 38 is formed with the number “6” on the axially-extending surface 38A, the third step 40 is formed with the number “4” on the axially-extending surface 40A and the fourth or bottom step 42 is formed with the number “2” on the axially-extending surface 42A.

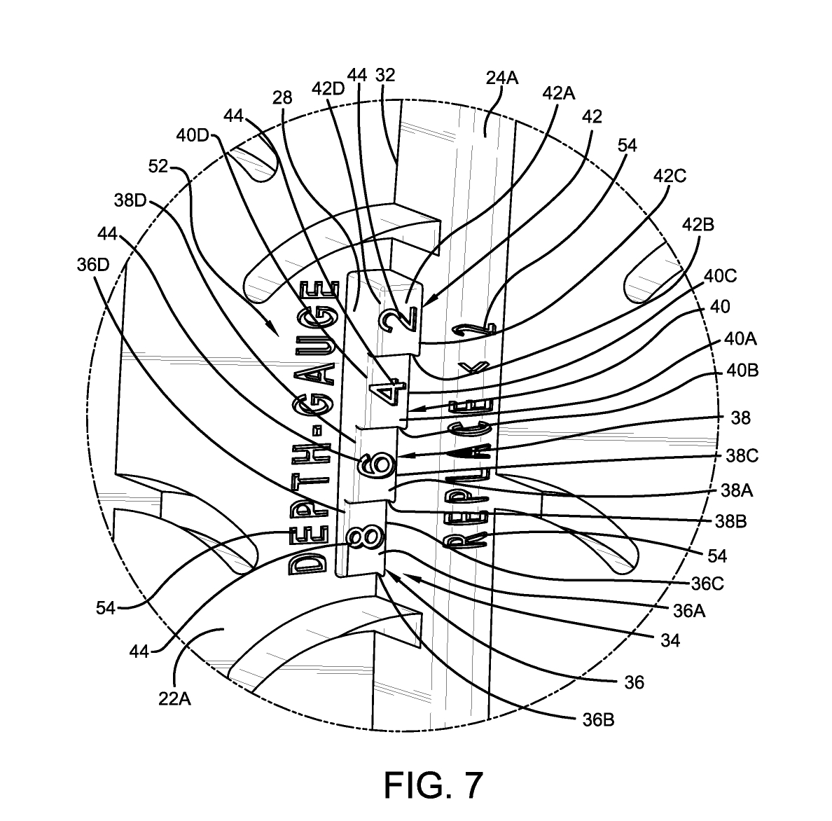

Additional indicia 54 may optionally be included on the tread surface 32 and/or the groove base 46 adjacent the tread wear indicator 52. For example, indicia 54 on the tread surface 32 may state “wear gauge” (FIG. 2) or “depth-gauge” (FIG. 7) to clearly inform a user of the purpose of the tread wear indicator 30 or 52, respectively. In addition, indicia 54 in the groove base 46 may clearly state when the tire is to be replaced, such as “replace <2”,which indicates that the tire should be replaced once the number “2” is no longer visible. Such replacement indicia 54 preferably are disposed in the groove base 46 in order to be visible when the remainder of the tread wear indicator 52 has worn away.

By being located in the selected tread element 22A adjacent the selected groove 24A, the second embodiment of the tread wear indicator 52 is easy for a user to see, does not interfere with the performance of the grooves 24 and 26 or the tread 20, and is economical to form.

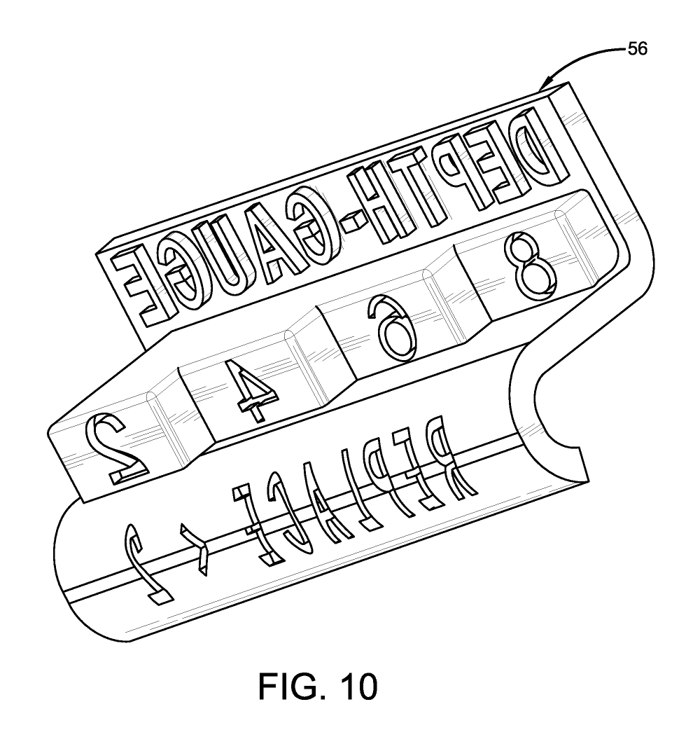

Turning to FIG. 10, the tread wear indicator 52 preferably is formed in the tire 10 when the tire is cured. To form the tread wear indicator 52, a die insert 56 is formed with the above-described features of the tread wear indicator. The die insert 56 is disposed in a corresponding opening formed in the tire curing mold, and when the tread 20 is formed on the tire 10 during curing, the tread wear indicator 30 is also formed. The die insert 56 may be 3D printed, cast or fabricated, and may be formed of any suitable mold material, including steel, aluminum and alloys thereof.

The present invention also includes a method of forming a tread wear indicator 30, 52 in a tire 10 and a method of using a tread wear indicator 30, 52 in a tire 10. Each method includes steps in accordance with the description that is presented above and shown in FIGS. 1 through 10.

It is to be understood that the structure of the above-described tread wear indicator may be altered or rearranged, or components or steps known to those skilled in the art omitted or added, without affecting the overall concept or operation of the invention. For example, heights for the step elements or indicia other than those described above may be employed without affecting the overall concept or operation of the invention.

The invention has been described with reference to preferred embodiments. Potential modifications and alterations will occur to others upon a reading and understanding of this description. It is to be understood that all such modifications and alterations are included in the scope of the invention as set forth in the appended claims, or the equivalents thereof.

What is claimed is:

1. A tread wear indicator for a tire, wherein the tire includes a pair of sidewalls and a tread, and the tread includes a plurality of tread elements defined by circumferential grooves and lateral grooves, the tread wear indicator comprising:
an indicator being formed in a selected one of the tread elements adjacent a selected one of the circumferential grooves;
the indicator including a plurality of step elements descending from a radially outward surface of the selected one of the tread elements toward the base of the selected one of the circumferential grooves;
each step element including an axially-extending surface being approximately parallel to and being radially inward of the radially outward surface of the selected one of the tread elements, and a radially-extending surface extending approximately perpendicular to the axially-extending surface; and
the axially-extending surface of each step element being formed with indicia visible to a user of the tire.

2. The tread wear indicator of claim 1, wherein the indicator includes at least four step elements.

3. The tread wear indicator of claim 1, wherein the axially-extending surface of each step element includes a square or rectangular shape.

4. The tread wear indicator of claim 1, wherein the axially-extending surface of each step element includes a first side edge being disposed adjacent the selected groove, and a second side edge being disposed against a wall area formed in the selected tread element.

5. The tread wear indicator of claim 1, wherein the axially-extending surface of each step element is disposed at a height that corresponds to a selected percentage of a recommended tread height.

6. The tread wear indicator of claim 1, wherein the indicia are oriented toward an outboard surface of the tire.

7. The tread wear indicator of claim 1, wherein the indicator is formed with an insert that is disposed in a mold which cures the tire.

8. The tread wear indicator of claim 1, wherein the plurality of step elements are formed in a single staircase configuration.

9. The tread wear indicator of claim 1, wherein the plurality of step elements are formed in a double staircase configuration, including a first set of step elements descending from the radially outward surface of the selected one of the tread elements to a bottom step, and a second set of step elements opposing the first set of step elements and descending from the radially outward surface of the selected one of the tread elements to the bottom step.

10. The tread wear indicator of claim 1, wherein the axially-extending surface of a first one of the step elements is disposed at a height that corresponds to about 75 percent of a recommended tread height, the axially-extending surface of a second one of the step elements is disposed at a height that corresponds to about 50 percent of the recommended tread height, the axially-extending surface of a third one of the step elements is disposed at a height that corresponds to about 25 percent of the recommended tread height, and the axially-extending surface of a fourth one of the step elements is disposed at a height that corresponds to about zero percent of the recommended tread height.

11. The tread wear indicator of claim 10, wherein the indicia formed on the axially-extending surface of the first one of the step elements includes the number 4, the indicia formed on the axially-extending surface of the second one of the step elements includes the number 3, the indicia formed on the axially-extending surface of the third one of the step elements includes the number 2, and the indicia formed on the axially-extending surface of the fourth one of the step elements includes the number 1.

12. The tread wear indicator of claim 10, wherein the indicia formed on the axially-extending surface of the first one of the step elements includes the number 8, the indicia formed on the axially-extending surface of the second one of the step elements includes the number 6, the indicia formed on the axially-extending surface of the third one of the step elements includes the number 4, and the indicia formed on the axially-extending surface of the fourth one of the step elements includes the number 2.

13. The tread wear indicator of claim 1, further comprising indicia formed on the radially outward surface of the selected one of the tread elements.

14. The tread wear indicator of claim 1, further comprising indicia formed in the base of the selected one of the circumferential grooves.
